(19) United States
(12) Patent Application Publication
(10) Pub. No.: US 2005/0250566 A1
(43) Pub. Date: Nov. 10, 2005

(54) Gaming apparatus

(75) Inventor: Martin Moshal, Gibraltar (ZA)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Waterleaf Limited

(21) Appl. No.: 10/513,692

(22) PCT Filed:
(86) PCT No.: PCT/IB03/01581

(30) Foreign Application Priority Data
May 9, 2002 (GB) 0210595.5

(51) Int. Cl. A63F 13/00

(52) U.S. Cl. 463/16; 463/42

(57) ABSTRACT

A gaming apparatus (1) includes three game display units (8a), each game display unit being capable of randomly selecting and displaying a set of indicia from a number of possible indicia sets. The number of possible indicia sets includes one or more winning indicia set. An activation facility is operable to cause activation of all of the game display units (8a) that independently and concurrently each select and display a corresponding indicia set from the number of possible indicia sets. The gaming apparatus (1) includes, further, a wagering facility that enables a user (7) to place a wager associated with each one of the game display unit (8a), and a detector means capable of detecting the selection and display of any winning indicia set by anyone of the game display units (8a).

### FIELD OF THE INVENTION

This invention relates to a gaming apparatus that enables a user thereof to place a wager on a game, and thereafter to play the game. More particularly, the invention relates to a gaming apparatus that enables a user thereof to place a wager on, and thereafter to play, a game of chance, such as a casino game. The invention extends to a method of operation of the gaming apparatus.

### BACKGROUND OF THE INVENTION

Games of chance are known and widely played for recreational purposes. In order to enhance the recreational experience for a player, it is common for the game of chance to enable the player to place of a wager on an outcome of the particular game being played. The wager is paid out at predetermined odds if the outcome of the game is successful, and forfeited by the player if the outcome of the game is unsuccessful. The determination as to whether any wager is successful or unsuccessful is determined according the rules of the game.

In this specification, the term “gaming apparatus'8 is taken to include any apparatus on which or with which the player may play a game of chance and associated with which the player may place a wager on an outcome of the game. The wager may be made with real currency, or with an equivalent of value, such as credits or tokens.

Generally, games of chance are repetitive in nature and consist of sequential cycles each including the following steps: placing a wager, generating one or more random events, determining whether the wager is successful or unsuccessful as a function of the random events, collecting the wager if unsuccessful, and paying the wager according to predetermined odds if the wager is successful. Examples of such repetitive games are roulette, blackjack, video poker and slots.

A problem with gaming and gaming apparata is that players can rapidly tire of any particular game and hence become bored. In order to avoid boredom and with consequent loss of interest in the game, and in order to enhance the player's recreational experience, it is desirable to provide the player with new games and additional opportunities to place wagers and to receive payouts for successful wagers.

It is also desirable for an experienced player of a game of chance to be able to play the game in a manner in which the necessity of undertaking repetitive actions is minimised, and in which the progress of the game is speeded up relative to a conventional manner in which the game is played.

### OBJECT OF THE INVENTION

It is an object of this invention to provide a gaming apparatus, and a method of operation thereof that will, at least partially, alleviate the above-mentioned difficulties and disadvantages.

### SUMMARY OF THE INVENTION

In accordance with this invention there is provided a gaming apparatus, comprising:
a plurality of different game units, each game unit being operable to randomly select and to display an indicia set from a number of possible indicia sets, the number of possible indicia sets including at least one winning indicia set;
a wagering facility capable of placing a wager associated with each one of the plurality of game units;
an activation facility operable to cause activation of all of the game units to independently and concurrently select and display a corresponding indicia set from the number of possible indicia sets; and
detector means capable of detecting the selection and display of the at least one winning indicia set by any one of the game units.

Further features of the invention provide for the gaming apparatus to include an annunciator means responsive to selection of the at least one winning indicia set by any one of the game units, to indicate to a user of the a gaming apparatus that a prize has been won, for each game unit to have a corresponding display unit, and for the display units corresponding to the plurality of game units to display their respective selected indicia sets in adjacent display locations.

Still further features of the invention provide for the number of possible indicia sets to include a plurality of different winning indicia sets, for each one of the different winning indicia sets to be associated with a corresponding prize, for each prize to be a corresponding predetermined quantity of credit, and for the gaming apparatus to include a settlement facility responsive to selection of any one of the plurality of different winning indicia sets to transfer to a user of the gaming apparatus a corresponding predetermined quantity of credit corresponding to the winning indicia set.

Yet further features of the invention provide for each indicia set to consist of at least three separate indicia, for each display unit to display the separate indicia of a selected indicia set in a side by side configuration, for a display unit to display each indicium of an indicia set on corresponding rotatable reel having a plurality of indicia circumferentially inscribed thereon, and for the activation facility to cause a game unit to select and to display an indicia set from the number of possible indicia sets by causing all the rotatable reels of the corresponding display unit to rotate axially and to subsequently come to rest at random positions, circumferentially.

The invention extends to a method of operation of a gaming apparatus, comprising the steps of:
providing a plurality of different game units, each game unit being operable to randomly select and to display an indicia set from a number of possible indicia sets, the number of possible indicia sets including at least one winning indicia set;
placing a wager associated with each one of the plurality of game units;
activating all of the game units to independently and concurrently select and display a corresponding indicia set from the number of possible indicia sets; and
detecting the selection and display of the at least one winning indicia set by any one of the game units.

There is further provided for the method to include the further step of indicating to a user of the a gaming apparatus that a prize has been won when the at least one winning indicia set has been selected by any one of the game units, and for displaying the respective indicia sets selected by the plurality of game units in adjacent display locations.

There is still further provided for including a plurality of different winning indicia sets in the number of possible indicia sets, for associating each one of the different winning indicia sets with a corresponding prize, for arranging each prize to be a corresponding predetermined quantity of credit, and for transferring to a user of the gaming apparatus, upon selection of any one of the plurality of different winning indicia sets, a corresponding predetermined quantity of credit corresponding to the winning indicia set.

There is yet further provided for including at least three separate indicia in each indicia set, for displaying the separate indicia of a selected indicia set in a side by side configuration, for displaying each indicium of an indicia set on a corresponding rotatable reel having a plurality of indicia circumferentially inscribed thereon, and for causing a game unit to select and to display an indicia set from the possible number of indicia sets by causing all the rotatable reels to rotate axially and to subsequently come to rest at random positions, circumferentially.

### BRIEF DESCRIPTION OF THE DRAWINGS

A preferred embodiment of the invention is described below, by way of example only, and with reference to the accompanying drawing in which:

FIG. 1 is a schematic representation of a gaming apparatus according to the invention; and

FIG. 2 is a functional representation of various game units and display units of the gaming apparatus of FIG. 1.

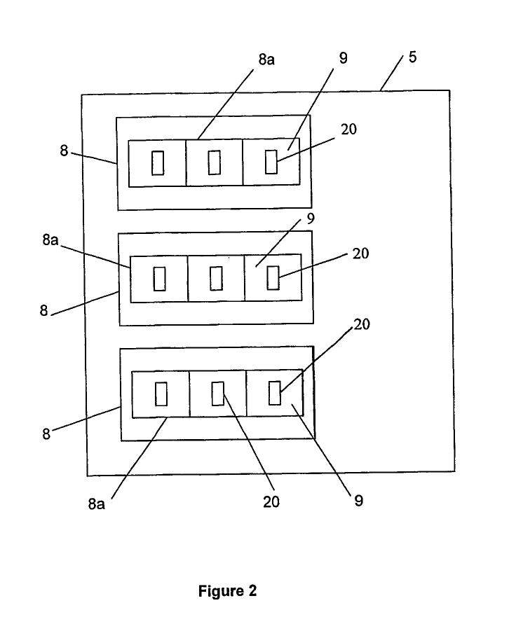

### DETAILED DESCRIPTION OF THE INVENTION

In the description that follows, an embodiment of the invention will be described with particular reference to a casino game of video slots. It is to be clearly understood, however, that the scope of the invention is not limited to this particular embodiment or application of the invention.

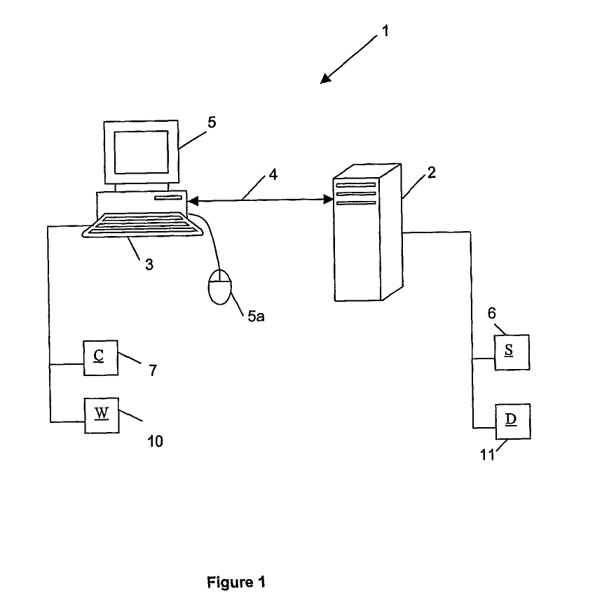

Referring to FIG. 1, a gaming apparatus is indicated generally by reference numeral (1). The gaming apparatus (1) includes a gaming server (2) and a player access facility in the form of a computer workstation (3) having a display screen (5) and an associated pointing device (5a), such as a mouse or, alternatively, a touchpad. The computer workstation (3) is remote from the gaming server (2) and is in communication therewith by means of a communication network (4) that is, in this embodiment, the Internet.

The computer workstation (3) is a conventional personal computer operating under a Windows 2000 operating system, which is well known and commercially available from the Microsoft Corporation of Seattle, Wash., USA. The computer workstation (3) and the gaming server (2) each execute different components of the casino game, under instruction of a player through a suitable man-machine interface (not shown) in the form of a GUI on the computer workstation (3).

The video slots casino game consists of a server process (6), which is executable in the gaming server (2), and a corresponding client process (7), which is executable in the computer workstation (3). The client process (7) renders, on the display screen (5), a representation of a conventional video slots machine. The representation on the display screen (5) consists of three separate game units (8), each of which includes a display unit (8a), which is itself divided into three sub-areas (9). Each game unit (8) is a dedicated area on the display screen (5), while the display unit (8a) is a subset of this dedicated display area. Each sub-area (9) is capable of displaying an indicium thereon. The three such game units (8) are adjacent one another in a vertical configuration, while the three sub-areas (9) of a display unit are arranged in a side-by-side configuration.

The server process (6) generates, upon request of the client process (7), a random event that represents, in this embodiment, an outcome of a spin of three reels of a slot machine, on which the game of video slots is based. The client process (7) obtains the result of the random event and displays the random event to a player on the display screen (5) in an intelligible manner.

Three indicia displayed in the three sub-areas (9) of a particular game display unit are referred to, collectively, as an indicia set. In this embodiment, each sub-area (9) displays a representation of the circumference of a reel (20) of a conventional slot machine, of a type that is well known in the art and which will not be described here in detail. The circumference of the reel (20) is displayed as having a plurality of different indicia circumferentially spaced thereon, the reel being capable of axial rotation and of subsequently coming to rest at a position in which a particular indicium corresponding to the outcome of the random event is visible in the sub-area (9).

It is an essential feature of this invention that the three game units (8) of the gaming apparatus (1) are independent of each other and are each capable of representing the outcome of a separate random event generated by the gaming server. Thus, each random event that is generated by the server process (6) manifests as a display, on a corresponding game unit (8), of three side-by-side spinning reels (20) that come to rest at predetermined positions to render an indicia set consisting of three individual indicia.

The client process (7) allows the player to make wagers on a turn of game of video slots. The GUI comprises images that are displayed on the display screen (5) under control of the client process (7), in combination with the pointing device (5a). The client process (7) outputs information and data to the player by displaying an appropriate image on the display screen (5). Data is input by the player to the client process (7) by utilising the pointing device to activate one or more clickable icons displayed on the display screen (5).

The client process (7) also provides a wagering facility (10), which enables a player to place a wager on the outcome of a turn of the game of video slots. The client process (7) also provides the player with an activation facility in the form of a clickable icon (not shown) that is displayed on the display screen (5). The icon (not shown) is activatable by the player to cause the server process (6) to generate a random event corresponding to each one of the game units (8). The different game units (8) each independently and concurrently select and display an indicia set corresponding to one of the generated random events. Each indicia set thus selected and displayed is one of a set of possible indicia set being a function of the number of game units (8), and the number of different indicia on each spinning reel.

A number of the possible indicia sets are designated as winning indicia sets, each associated with a corresponding prize, such as an amount of credit to be awarded to the player when the winning indicia set is selected and display on one of the game units (8). The server process (6) provides a detector means (11), which is capable of detecting the selection and display of such a winning indicia set by any one of the game units (8).

In use, the player is required to decide on an appropriate size of wager on a next turn of the game of video slots, and the same size of wager is applied uniformly to each one of the individual game units (8) The user then explicitly initiates the particular turn of the game by activating the activation facility (not shown) with the pointing device (5a). It is a further essential feature of this invention that activation of the activation facility (not shown) causes generation of an independent random event corresponding to each one of the three game units (8), and that each one of the random events is displayed on the display screen (5) on a corresponding display unit (8a) as a corresponding indicia set, without further intervention from the player. The process manifests as the reels of each one of the display units (8a) spinning and coming to rest at predetermined positions to display, jointly, separate indicia sets, each consisting of three individual indicia. The detector means (not shown) detects selection and display of a winning indicia set by any of the game units (8) and settles any winning wager by making available a corresponding amount of credit to the player.

It will be appreciated by those skilled in the art that operation of the gaming apparatus (1) in this manner enables a player to play multiple turns of a game of video slots simultaneously. The multiple turns of the game are initiated simultaneously and independently, without further intervention from the player.

It will also be further appreciated by those skilled in the art that the gaming apparatus (1) of the invention enables a player of the video slots game to simultaneously decide multiple spins of the game in a mode of play in which the necessity of undertaking repetitive actions or tasks is minimised, and in which the progress of the game is speeded up relative to a conventional manner in which the game is played.

It is envisaged that the gaming apparatus will provide a player of the casino game with increased excitement relative to known prior art video slots apparata as more than one result is revealed to the player in each turn of the game. Further, the gaming apparatus will be more pleasing to the player than the prior art apparata, as a higher proportion of turns of the game is likely to result in at least one wining wager for the payer who will consider all such turns of the game as successful game plays.

Numerous modifications are possible to this embodiment without departing from the scope of the invention. In particular, the gaming apparatus (1) is directly applicable to casino games other than video slots, such as roulette, video poker, or any other game for example. Further, the gaming apparatus (1) can be a self-contained apparatus that does not operate in an on-line environment, such as an electronic gaming device of a type commonly found in land-based casinos, or a hand-held gaming devices. Still further, the gaming apparatus (1) may have a greater or lesser number of display units than the three units described in this embodiment. The gaming apparatus (1) will, however, always consist of a minimum of two display units. Similarly, the number of indicia in an indicia set may differ from the three that are described in this embodiment. Yet further, the communication channel (4) may be a closed communication channel, or an open communication channel other than the Internet.

The invention therefore provides a gaming apparatus that allows a user of the system to play multiple simultaneous turns of a casino game in a flexible manner.

1-23. (canceled)

24. A gaming apparatus, comprising:
a plurality of different game units, each game unit being operable to randomly select and to display an indicia set from a number of possible indicia sets, the number of possible indicia sets including at least one winning indicia set;
a wagering facility operable by a user of the gaming apparatus to place a separate wager associated with each one of the plurality of different game units, respectively;
an activation facility operable by the user to cause simultaneous activation of all of the game units to cause each game unit to independently and concurrently select and display a corresponding indicia set from the number of possible indicia sets; and
detector means capable of detecting the selection and display of the at least one winning indicia set by any one of the plurality of game units.

25. A gaming apparatus as claimed in claim 24 in which each game unit has a corresponding display unit capable of displaying the respective indicia set selected by that game unit.

26. A gaming apparatus as claimed in claim 25 in which each display unit displays the separate indicia of a selected indicia set in a side by side configuration.

27. A gaming apparatus as claimed in claim 26 in which each display unit displays each indicium of an indicia set on a corresponding rotatable reel having a plurality of indicia circumferentially inscribed thereon.

28. A gaming apparatus as claimed in claim 27 in which the activation facility causes a game unit to select and to display an indicia set from the number of possible indicia sets by causing all the rotatable reels of the corresponding display unit to rotate axially and to subsequently come to rest at random positions, circumferentially.

29. A gaming apparatus as claimed in claim 24 in which the number of possible indicia sets includes a plurality of different winning indicia sets, each one of the plurality of different winning indicia sets being associated with a corresponding prize.

30. A gaming apparatus as claimed in claim 29 in which each prize is a corresponding predetermined quantity of credit.

31. A gaming apparatus as claimed in claim 30 which includes a settlement facility responsive to selection of any one of the plurality of different winning indicia sets to transfer to the user of the gaming apparatus a predetermined quantity of credit corresponding to the winning indicia set.

32. A gaming apparatus as claimed in claim 29 which includes an annunciator means responsive to selection of the at least one winning indicia set by any one of the plurality of game units, to notify the user of the gaming apparatus that a prize has been won.

33. A method of operation of a gaming apparatus, comprising the steps of:
providing a plurality of different game units, each game unit being operable to randomly select and to display an indicia set from a number of possible indicia sets, the number of possible indicia sets including at least one winning indicia set;
placing a separate wager associated with each one of the plurality of game units;
simultaneously activating all of the game units to cause each game unit to independently and concurrently select and display a corresponding indicia set from the number of possible indicia sets; and
detecting the selection and display of the at least one winning indicia set by any one of the game units.

34. A method as claimed in claim 33 that includes a further step of displaying the separate indicia of a selected indicia set in a side-by-side configuration.

35. A method as claimed in claim 34 in which each indicium of an indicia set is displayed on a corresponding rotatable reel having a plurality of indicia circumferentially inscribed thereon.

36. A method as claimed in claim 35 in which a game unit selects and displays an indicia set from the possible number of indicia sets by causing all the rotatable reels to rotate axially and to subsequently come to rest at random positions, circumferentially.

37. A method as claimed in claim 33 which includes the step of defining a plurality of different indicia sets in the number of possible indicia sets as winning indicia sets, each one of the different winning indicia sets being associated with a corresponding prize.

38. A method as claimed in claim 37 in which each prize is arranged to be a corresponding predetermined quantity of credit.

39. A method as claimed in claim 38 that includes the step of transferring to a user of the gaming apparatus, upon selection of any one of the plurality of different winning indicia sets, the corresponding predetermined quantity of credit corresponding to that winning indicia set.

40. A method as claimed in claim 37 which includes a further step of indicating to a user of the a gaming apparatus that a prize has been won when the at least one winning indicia set has been selected by any one of the game units.
